(19) United States
(12) Patent Application Publication
(10) Pub. No.: US 2018/0151971 A1
(43) Pub. Date: May 31, 2018

(54) Internal and External Connector and Receptacle

(71) Applicant: Daniel Anthony Poliseno, Hartly, DE (US)

(72) Inventor: Daniel Anthony Poliseno, Hartly, DE (US)

(21) Appl. No.: 15/626,642

(22) Filed: Jun. 19, 2017

Related U.S. Application Data
(60) Provisional application No. 62/323,786, filed on Apr. 17, 2016.

(51) Int. Cl. H01R 12/73; H01R 12/72; H01R 12/71; H01R 13/24

(52) U.S. Cl. CPC H01R 12/732; H01R 13/24; H01R 12/714; H01R 12/721

(57) ABSTRACT

A connector with internal and external contacts is provided. The connector has one set of internal contacts for receiving or transmitting data or electricity. The connector has one set of external contacts for receiving or transmitting data or electricity. The connector plug's internal and external contact sets are configurable to the specification of the device. A corresponding receptacle has corresponding internal and external contacts which symmetrically align with the connector plug. The receptacle can be included in a device and has the related circuitry to appropriate which combination of audio, video, data, and electric signals are to be transmitted through either the internal or external contact sets. Both internal and external contact sets of the receptacle and connector plug are configurable to the specification of the device as to allow simultaneous transmission of audio, video, data, and other electric signals at the full capacity or capability of the device.

### CROSS-REFERENCE TO RELATED DOCUMENTS

The present application claims the benefit of U.S. Provisional Application No. 62/323,786, filed Apr. 17, 2016, the disclosure of which is incorporated herein at least by reference.

### BACKGROUND OF THE INVENTION

### 1. Field of the Invention

The present invention relates generally to electrical connectors that facilitate the transmission of electricity, audio, video, and other types of data in number of electronic devices such as mobile phones, smartphones, personal computers, tablets, and music players. In particular, a more efficient and adaptable connector and receptacle that can be used in place of standard connectors available.

### 2. Description of Related Art

Currently, there are a wide variety of available connectors and connection ports for electronic devices that are utilized for the transfer of electricity, data, and other signals. Currently available connectors are limited because their scope or capabilities, a manufacturer must choose a particular connector based on the needs of the manufactured device or application.

This is especially problematic for manufacturers of devices such as personal computers, mobile phones, smartphones, pc tablets, music players, and others. Present connectors and receptacles available today are limited in their ability to transmit audio, data, and electricity at full capability or capacity due to inherent design limitations. Manufacturers sometimes must limit the capabilities of the device because of the current connectors and receptacles presently available.

Therefore what is clearly needed is a connector and receptacle that has a dual set of many contact points that can be configured to function independently or in sync and able to simultaneously accommodate electrical or data signals at an increased rate allowing for currently manufactured devices to function more efficiently or expand future devices capabilities.

### BRIEF SUMMARY OF THE PRESENT INVENTION

The subject invention comprises embodiments for a receptacle connector of which internal and external contact sets can be configured to be dynamic or dedicated based on the need of a determined function for each contact set. In addition, the connector plug has both interior and exterior contacts that mates with the receptacle in manner that the configured dynamic and dedicated contact sets of the receptacle align. Additional embodiments of this invention pertain to the connector plug that corresponds with the receptacle of this invention. Other embodiments of the invention relate to the connector plug securing to the receptacle connectors. An exemplary connector plug and receptacle that; transmits simultaneous signals at full capacity or capability accepted by the device, a connector plug that has both interior and exterior contacts that mates with the receptacle in manner that the contact sets align, a connector plug and receptacle of which both interior and exterior contact sets can be configured to be either dynamic or dedicated in any desired combination.

To better understand the nature and advantages of the present invention, reference should be made to the following description and accompanying figures. It is to be understood, however, that each of the figures is provided for the purpose of illustration only and is not intended as a definition of the limits of the scope of the present invention.

### BRIEF DESCRIPTION OF THE SEVERAL VIEWS OF THE DRAWINGS

FIG. 1A is a top schematic view of a connector plug according to an embodiment of this invention;

FIG. 1B is a bottom schematic view of a connector plug according to an embodiment of this invention;

FIG. 1C is a simplified perspective top schematic view of a connector plug according to an embodiment of this invention;

FIG. 1D is a simplified perspective bottom schematic view of a connector plug according to an embodiment of this invention;

FIG. 1E is a simplified perspective view of a connector plug according to an embodiment of this invention;

FIG. 2A is a simplified perspective view of a receptacle according to an embodiment of this invention; illustrates a front elevation view of the exemplary receptacle;

FIG. 2B is a simplified perspective cross-sectional schematic view of a receptacle according to an embodiment of this invention;

FIG. 3 is a diagram illustrating communication between electronic and/or media devices and/or the transfer of electricity to an electronic and/or media device via the connector plug and receptacle installed according to an embodiment of this invention.

### DETAILED DESCRIPTIONS OF THE PREFERRED EMBODIMENT

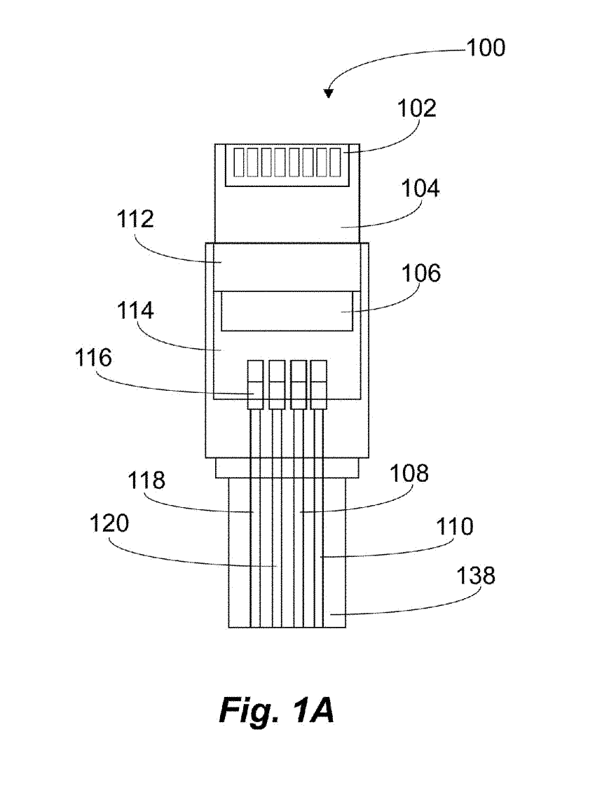

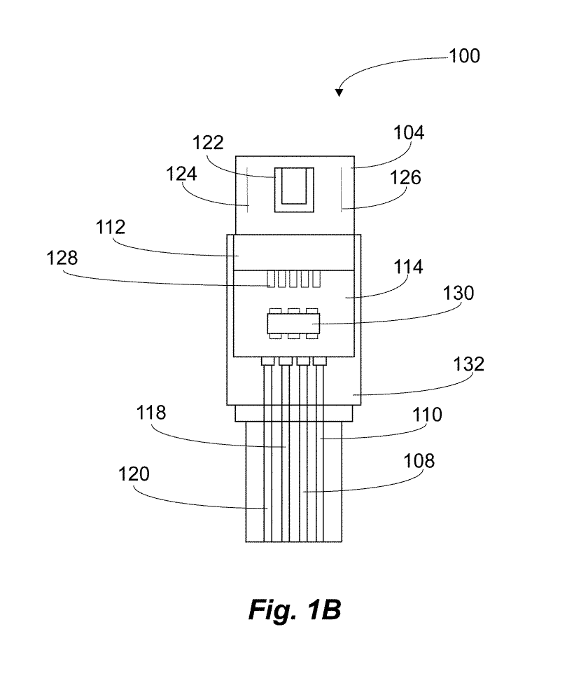

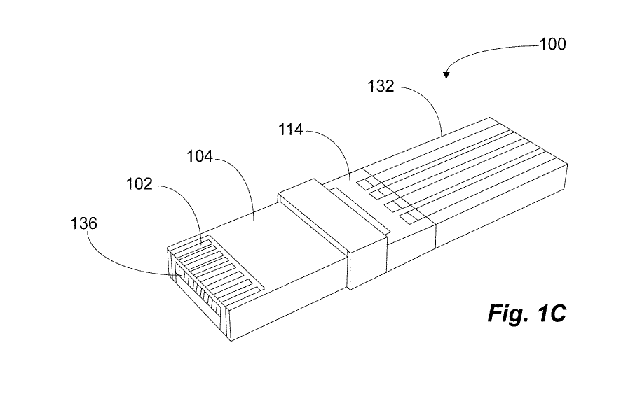

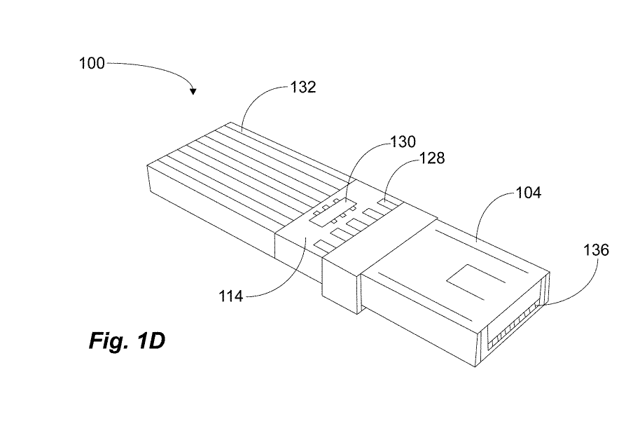

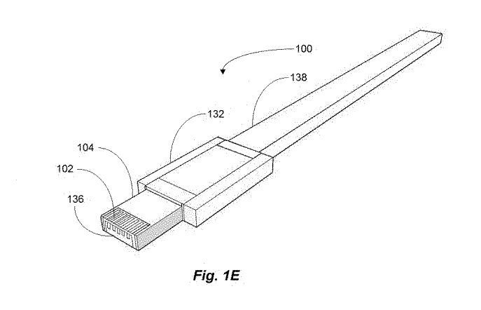

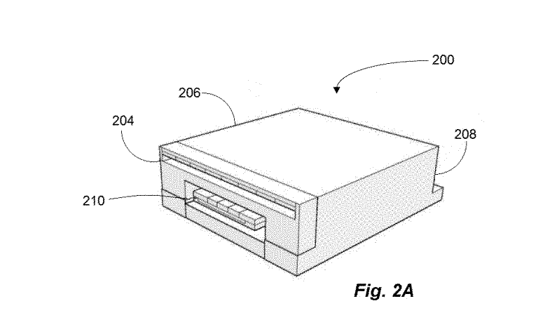

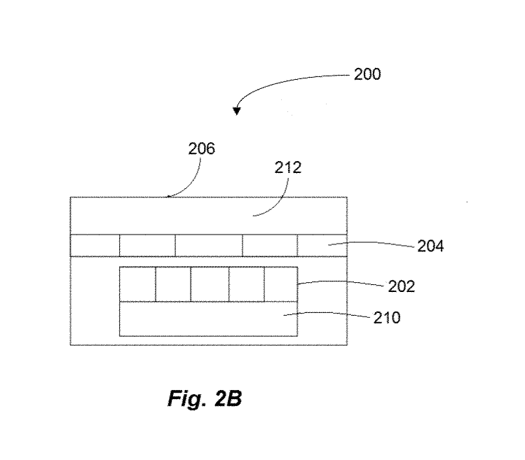

To better understand the present invention, referring to the Figures wherein like numerals indicate like or corresponding parts throughout several views, an exemplary internal and external connector plug 100 is shown in FIG. 1A, FIG. 1B, FIG. 1C, FIG. 1D, and FIG. 1E. In one embodiment of the present invention an exemplary connector tip casing 132 (as shown in FIG. 1B) can be made of a semi-crystalline high temperature thermoplastic in an injecting molding process. As shown, the connector plug includes a distal connector tab 104 that extends from the connector plug. Distal connector tab 104 can be made of metal or metal alloy and in one embodiment is made of stainless steel electroplated with nickel. Distal connector tab 104 has a front major surface, a top major surface, a bottom major surface, and two side minor exposed surfaces. Eight or more external contacts 102 are positioned on the top major surface as well as five or more internal contacts 136 are positioned on the front major surface of the distal connector tab 104 (as shown in FIG. 1C). The eight or more external contacts 102 and five or more internal contacts 136 can be made of metal or any appropriate conductive material. Appropriately, the spacing between the eight or more external contacts 102 on the top major surface and the five or more internal contacts 136 on the front major surface can correspond to the uppermost receptacle internal contacts 204 and the centered receptacle internal contacts 210 (as shown in FIG. 2A). Symmetrically, the eight or more external contacts 102 and five or more internal contacts 136 contacts (as shown in FIG. 1C) can correspond to the uppermost receptacle internal contacts 204 and the centered receptacle internal contacts 210 (as shown in FIG. 2A).

Attached to the proximal end of the exemplary connector plug is a securing item 112 intended to secure the distal connector tab 104 to the printed circuit board (PCB) 114 providing for durability of use. In FIG. 1A, the printed circuit board (PCB) 114 facilitates electricity and/or data transmission from contacts to the insulated metallic wires 108, 110, 118, and 120. The insulated metallic wires 108, 110, 118, and 120 can be made of a conductive metal alloy to facilitate transmission and insulated to aid in safety and durability. In FIG. 1A, on printed circuit board (PCB) 114, electricity and data flow from the multiple contacts to the PCB via the processing micro-chip 106 and subsequently to the soldered contact points 116 to insulated metallic wires 108, 110, 118, and 120, ultimately facilitating the flow of electricity and data to the electronic device.

In FIG. 1B, of the exemplary connector plug, the bottom side of the distal connector tab 104 has a right securing item 126 and left securing item 128 intended to secure the connector plug into the receptacle but also to be removed with little effort. A centered securing item 122 is also intended to provide additional securing but easy to remove. The printed circuit board (PCB) 114 facilitates the transmission between the distal connector tab 104 and the insulated metallic wires 108, 110, 118, and 120. Located on the bottom side of the printed circuit board (PCB) 114 are five or more additional securing soldered contact points 128 that transfer via the sensor micro-chip 130 to insulated metallic wires 108, 110, 118, and 120. The sensor micro-chip 130, insulated metallic wires, processing micro-chip 106, soldered contact points 116, additional securing soldered contact points 128, and processing micro-chip 106, can each be soldered to the corresponding contact points on the printed circuit board (PCB) 114 to form the complete circuit.

As shown in FIG. 1C, the eight or more external contacts 102 are exposed at the most distal top major surface of the distal connector tab 104 and connect to the printed circuit board (PCB) 114 at the contact points processing micro-chip 106 soldered to the printed circuit board (PCB) 114. As shown in FIG. 1D, the front major surface five or more internal contacts 136 are exposed at the most distal front major surface of the distal connector tab 104 and connect to the printed circuit board (PCB) 114 at the corresponding soldered contact points 128 soldered to the printed circuit board (PCB) 114. In FIG. 1E, an exemplary internal and external connector plug 100 and cable 138 is shown. The cable 138 is secured to the connector tip casing 132 creating a water resistant seal. The cable 138 is formed when the interior insulated metallic wires 108, 110, 118, and 120 are enclosed in a preferably non-conductive and water resistant material, further encased by an outer preferably non-conductive and water resistant material layer.

An exemplary internal and external connector receptacle is shown in FIG. 2A and FIG. 2B. FIG. 2A illustrates a side-view of the exemplary receptacle 200 for use with the connector plug 100. The receptacle housing 206 which encases an interior receptacle printed circuit board (PCB) 208 as well as the uppermost receptacle internal contacts 204 and the centered receptacle internal contacts 210 (as shown in FIG. 2A). In one embodiment of the present invention an exemplary receptacle housing 206 (as shown in FIG. 2A) can be made of a semi-crystalline high temperature thermoplastic in an injecting molding process. Additionally, two cavities are positioned in the receptacle housing 206 located immediately below and around the eight or more uppermost receptacle internal contacts 204 and the five or more centered receptacle internal contacts 210 allowing the connector plug to fit securely into the receptacle. In some embodiments, five or more corresponding contact points of the centered receptacle internal contacts 202 are arranged in the center of receptacle housing 206 and eight or more corresponding uppermost receptacle internal contacts 204 are arranged along the top side of the receptacle housing 206. The eight or more external contacts 102 and five or more internal contacts 136 can be made of metal or any appropriate conductive material.

The centered receptacle internal contacts 202 and the uppermost receptacle internal contacts 204 receive and transmit electricity, data, and other types of signals from the device of which the receptacle is installed through the cable to the power source or electronic device to which it is connected. The receptacle 200 circuit can be completed by soldering the corresponding insulated metallic and conductive wires on the PCB 208 to the eight or more uppermost receptacle internal contacts 204 and the five or more centered receptacle internal contacts 210 receiving and transmitting assemblies. Using the connector plug 100, the distal connector tab 104 is inserted into the receptacle 200. When inserted, the eight or more uppermost receptacle internal contacts 204 of the receptacle 200 symmetrically meet the eight or more external contacts 102 of the connector plug 100. Simultaneously, the five or more internal contacts 136 of the connector plug 100 meet the centered receptacle internal contacts 202. When the distal connector tab 104 of the connector plug 100 is fully inserted into the receptacle 200, a circuit is completed which facilitates the transmission of data and/or electricity simultaneously as desired.

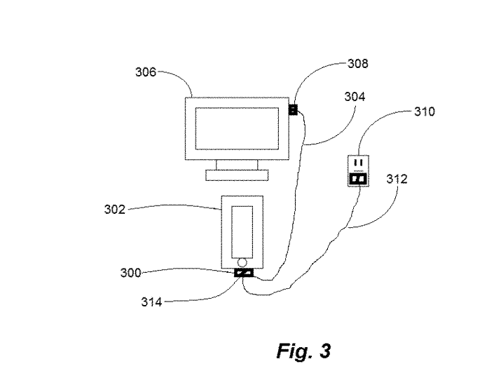

FIG. 3 illustrates the preferable use of the present invention and how it can be used with present devices. The preferable use of the present invention would have a user insert and connect the exemplary internal and external connector plug 314 into the exemplary internal and external receptacle 300. The receptacle 300 which after being installed and part of an electronic media device 302, allows for the transfer the transmission of data and/or electricity from one media device 302 to another or from a standard electrical outlet 310 to the media device 302. The receptacle 300 can be installed in a media device 302. By inserting the connector plug 314 into the receptacle 300 a circuit is formed of which electricity can be transferred through insulated metallic wires which are encased in a cable 304 and inserted into a standard electrical receptacle 310.

Additionally, the receptacle 300 can be installed in a desktop computer 306. By inserting the connector plug 314 into the receptacle 300, a circuit is formed, of which electricity and/or data can be independently or simultaneously transferred through insulated metallic wires which are encased in a cable 304 and inserted into a media device 302 which also has installed the receptacle 300, a circuit is completed facilitating electricity and/or data to transfer between the desktop computer 306 and media device 302.

The invention has been illustratively described and the terminology used is intended to be words of description rather than words of limitation. Variations and modifications of the present invention are possible such as repositioning the electrical contacts on or within the connector and receptacle. Another possible variation and modification may be a more sophisticated circuit board and sensors. The invention seeks to provide a sophisticated connector and receptacle for the simultaneous transmission of audio, video, data, and electric signals between electronic devices.

1. A connector plug assembly for the transfer of data and electricity between electronic devices.

2. (canceled)

3. (canceled)

4. (canceled)

5. (canceled)

6. A receptacle assembly comprising: Two cavities positioned in the receptacle housing located immediately below and around the eight or more uppermost receptacle internal contacts and five or more centered receptacle internal contacts.

7. (canceled)

8. (canceled)

9. (canceled)

10. (canceled)

11. The connector plug assembly of claim 1 wherein the distal connector tab is comprised of eight or more external contacts positioned on the top major surface as well as five or more internal contacts positioned on the front major surface.

12. The connector plug assembly of claim 1 wherein the two sets of exterior contacts and interior contacts that can be dynamically configured to facilitate the simultaneous transmission of electrical and data signals not limited to their positioning.

13. The receptacle assembly of claim 6 wherein two cavities positioned in the receptacle housing contain eight or more uppermost receptacle internal contacts and five or more centered receptacle internal contacts. The two sets of exposed interior contacts can be dynamically configured to facilitate the simultaneous transmission of electrical and data signals not limited to their positioning.
